(19) United States
(12) Patent Application Publication
(10) Pub. No.: US 2007/0278811 A1
(43) Pub. Date: Dec. 6, 2007

(54) System for operably coupling a vehicle cab to a vehicle

(76) Inventors: Christopher D. Derham, East Peoria, IL (US); Clifton R. Gerke, Peoria, IL (US); Aaron R. Hayes, Emden, IL (US); Danny L. Weibling, Metamora, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/443,297

(22) Filed: May 31, 2006

(51) Int. Cl. B62D 24/04

(52) U.S. Cl. 296/35.1; 296/190.07

(57) ABSTRACT

A system is disclosed for operably coupling a vehicle cab to a vehicle. The system includes a damping mount configured to at least partially inhibit transmission of shocks and vibrations from the vehicle to the vehicle cab. The system further includes a mounting stud configured to operably couple the damping mount to one of the vehicle and the vehicle cab. The system further includes at least one stop member configured to limit at least one of load on the mounting stud and separation of the vehicle cab from the vehicle. The system further includes at least one fastener configured to operably couple the at least one stop member and the damping mount to the other of the vehicle and the vehicle cab.

### TECHNICAL FIELD

The present disclosure relates generally to a system and method for operably coupling a vehicle cab to a vehicle, more particularly, to a system and method for operably coupling a vehicle cab to a vehicle frame.

### BACKGROUND

A vehicle cab may serve several purposes. For vehicles such as work machines, for example, wheel-loaders, front-end loaders, dozers, and excavators, it may be desirable for a vehicle cab to provide a vehicle operator with protection from the elements and/or a comfortable environment in which to operate the vehicle. In addition, it may be desirable for the vehicle cab to not unduly limit access to vehicle components, for example, so that such vehicle components may be inspected and/or serviced.

One example of a tractor cab is described in U.S. Reissue Pat. No. 29,123 (the '123 patent) issued to Malm et al. on Jan. 25, 1977. The '123 patent describes a tractor cab and control console that are vibration-isolated from a tractor chassis by securing the tractor cab to the tractor chassis by resilient mount assemblies, which provide vibration isolation. The '123 patent's tractor cab is removable from the tractor chassis, and during assembly of the tractor, the control console may be mounted to the tractor chassis prior to adding the tractor cab to the tractor chassis.

Although the tractor cab of the '123 patent may provide some vibration isolation from the tractor chassis and may be removable from the tractor chassis, the '123 patent's tractor cab may not provide adequate operator comfort and/or ease of access to other vehicle components once the tractor has been assembled.

The disclosed system and method for operably coupling a vehicle cab to a vehicle may be directed to overcoming one or more of the desires set forth above.

### SUMMARY OF THE INVENTION

In one aspect, the present disclosure includes a system for operably coupling a vehicle cab to a vehicle. The system includes a damping mount configured to at least partially inhibit transmission of shocks and vibrations from the vehicle to the vehicle cab. The system further includes a mounting stud configured to operably couple the damping mount to one of the vehicle and the vehicle cab. The system further includes at least one stop member configured to limit at least one of load on the mounting stud and separation of the vehicle cab from the vehicle. The system further includes at least one fastener configured to operably couple the at least one stop member and the damping mount to the other of the vehicle and the vehicle cab.

According to another aspect, a system for operably coupling a vehicle cab to a vehicle includes a cab mount configured to be operably coupled to the vehicle cab. The system further includes a frame mount configured to be operably coupled to the vehicle and to the cab mount. The cab mount and the frame mount are configured to be coupled to one another such that the vehicle cab and the vehicle are pivotally coupled to one another, and one of the cab mount and the frame mount includes a viscous mount configured to provide damping between the vehicle cab and the vehicle.

According to a further aspect, a vehicle includes a cab from which to operate the vehicle, a vehicle frame, and a system for operably coupling the cab to the vehicle frame. The system includes at least one cab mount operably coupled to the cab. The system further includes at least one frame mount operably coupled to the vehicle frame. The cab mount and the frame mount are configured to be operably coupled to one another such that the cab and the vehicle are pivotally coupled to one another, and one of the cab mount and the frame mount includes a viscous mount configured to provide damping between the cab and the vehicle.

According to yet another aspect, a method for providing comfort to a vehicle operator and access to vehicle components includes mounting a cab to a vehicle such that the cab is supported by at least one mount configured to provide damping support between the cab and the vehicle and to operably couple the cab to the vehicle such that the cab may be pivoted with respect to the vehicle.

### BRIEF DESCRIPTION OF THE DRAWINGS

FIG. 1 is a diagrammatic perspective view of an exemplary embodiment of a vehicle cab in an orientation allowing access to other vehicle components.

FIG. 2 is a diagrammatic, partial perspective view of an exemplary embodiment of a system for operably coupling a vehicle cab to a vehicle.

FIG. 3A is a diagrammatic, partial perspective view of an exemplary embodiment of a system for operably coupling a vehicle cab to a vehicle along with of an exemplary vehicle cab in an orientation allowing access to other vehicle components.

FIG. 3B is a diagrammatic, partial perspective view of an exemplary embodiment of a system for operably coupling a vehicle cab to a vehicle along with of an exemplary vehicle cab in an orientation allowing access to other vehicle components.

FIG. 3C is a diagrammatic, perspective inverted view of an exemplary embodiment of a portion of a system for operably coupling a vehicle cab to a vehicle.

FIG. 3D is a diagrammatic perspective view of an exemplary embodiment of a portion of a system for operably coupling a vehicle cab to a vehicle.

FIG. 4 is a diagrammatic perspective view of a portion of an exemplary embodiment of a system for operably coupling a vehicle cab to a vehicle.

FIG. 5 is a diagrammatic, partial cross-section view of the exemplary embodiment of FIG. 4.

FIG. 6 is a diagrammatic, partial cross-section view of another exemplary embodiment of a system for operably coupling a vehicle cab to a vehicle.

### DETAILED DESCRIPTION

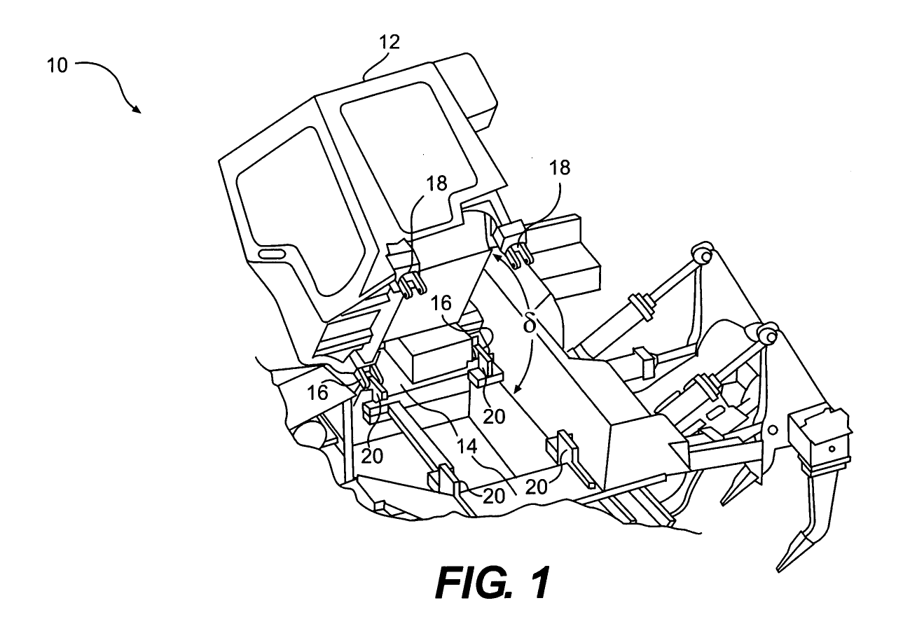

FIG. 1 illustrates an exemplary vehicle 10, such as, for example, a machine that includes an exemplary embodiment of a vehicle cab 12. Although the exemplary vehicle 10 depicted in FIG. 1 is a track-type tractor, vehicle 10 may be a track-type loader, a hydraulic excavator, a mining truck, a wheel loader, or another machine known to those having skill in the art. Exemplary vehicle cab 12 may be used with other vehicle types, such as, for example, trucks and cars.

Referring to the exemplary embodiments depicted in FIG. 1, vehicle 10 may include a frame 14 configured to support a power source and other components or systems of vehicle 10, and vehicle cab 12 may be configured to provide access to the other components and systems. For example, vehicle cab 12 may be configured to pivot with respect to vehicle frame 14, thereby permitting access to various component systems within vehicle 10. For example, vehicle cab 12 may be configured to pivot an angle δ with respect to horizontal ranging from about 45 degrees to about 90 degrees (e.g., about 70 degrees). For example, vehicle cab 12 may be configured to pivot along a line substantially parallel to a longitudinal axis of vehicle cab 12. In addition, vehicle cab 12 may be configured to pivot an intermediate amount such as, for example, to an angle δ with respect to horizontal ranging from about 10 degrees to about 30 degrees (e.g., about 20 degrees). By virtue of pivoting an intermediate amount, it may be possible to perform a quick visual inspection or conduct minor troubleshooting of various vehicle components and/or systems.

Vehicle 10 may be provided with a system configured to operably connect vehicle cab 12 to vehicle 10 such as cab mounts including, for example, a pair of pivoting cab mounts 16 and a pair of connecting cab mounts 18. Frame 14 may be provided with frame mounts 20, and pivoting cab mounts 16 may be configured to pivot with respect to frame mounts 20. Connecting cab mounts 18 may be configured to be removably connected to frame mounts 20.

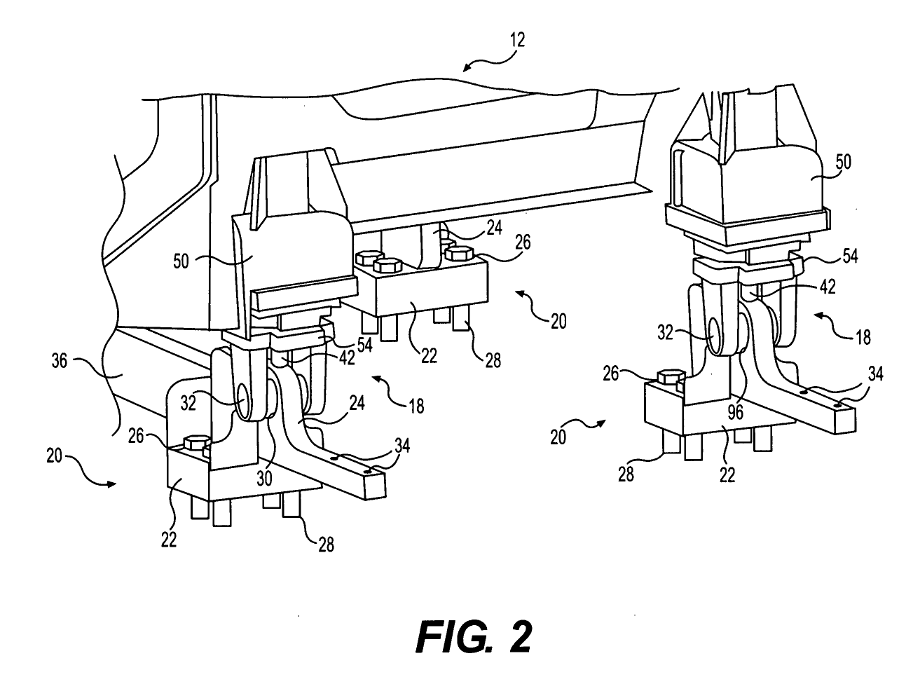

Frame mounts 20, for example, as depicted in FIG. 2, may include a base 22 and an upstanding frame link 24. Base 22 may be provided with a plurality of apertures 26 configured to receive fasteners 28 (e.g., bolts), such that base 22 may be secured to frame 14. Frame link 24 may be provided with a transverse aperture 30 configured to receive a lynch pin 32. Frame link 24 may further include a plurality of apertures 34 configured to permit attachment of other components, such as, for example, a platform. In addition, a cross member 36 may be provided between the two forwardmost frame mounts 20.

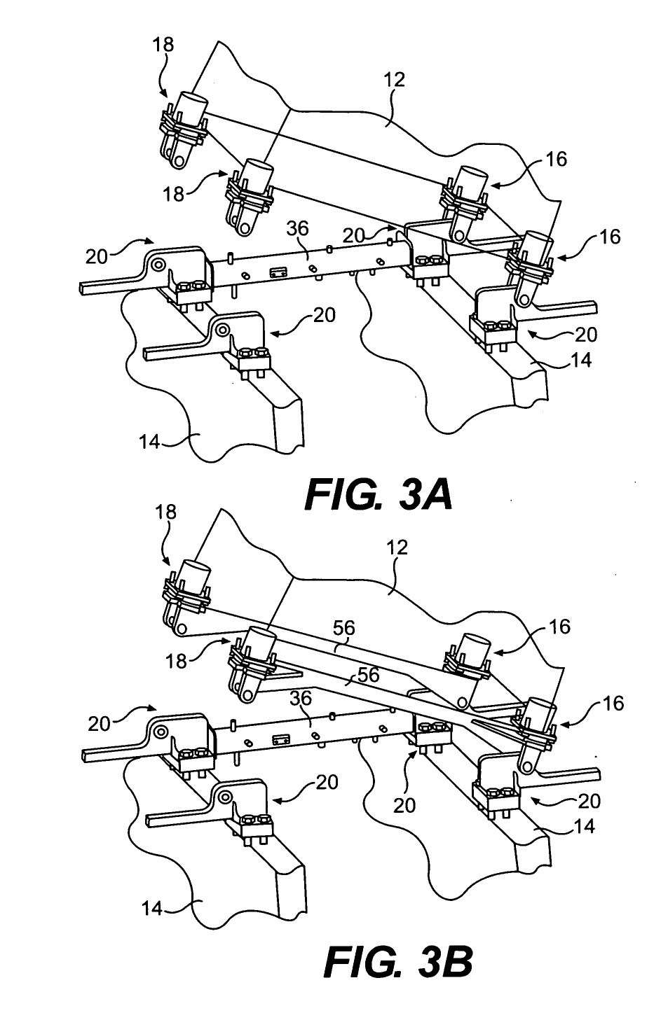

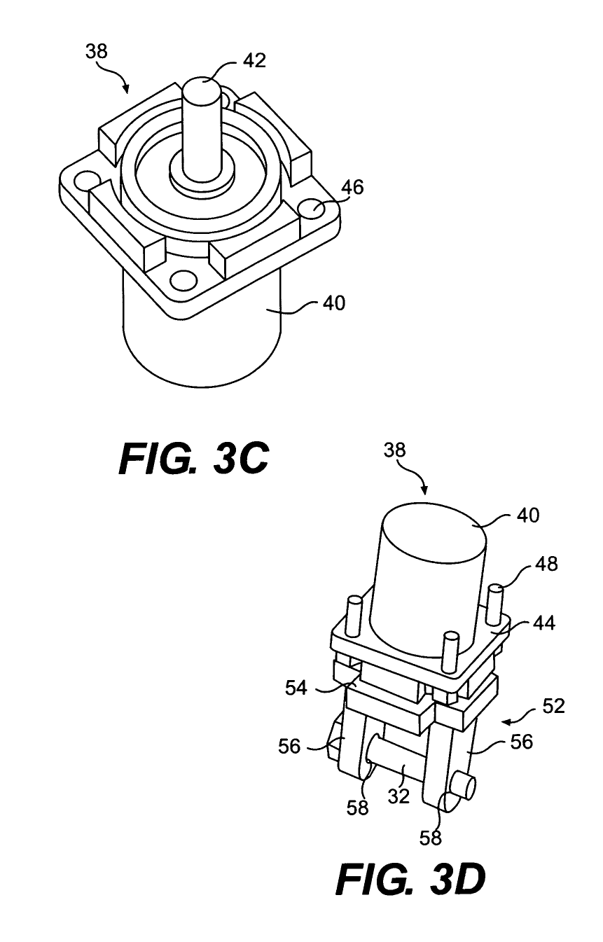

Referring to the exemplary embodiments depicted in FIGS. 2, 3A, 3B, 3C, and 3D, pivoting cab mounts 16 and connecting cab mounts 18 may include damping mounts 38, which may be configured to reduce and/or dampen vibrations transmitted from frame 14 to vehicle cab 12. Damping mounts 38 may include a housing 40 and a mounting stud 42 configured to connect damping mounts 38 to vehicle 10. Damping mounts 38 may further include a flange 44 provided with apertures 46 configured to receive fasteners 48 (e.g., bolts) for positioning damping mounts 38 adjacent to retainers 50 in vehicle cab 12 (see, e.g., FIG. 2), such that housings 40 of damping mounts 38 are received in retainers 50. Damping mounts 38 may provide a more comfortable environment for the operator, which may act, for example, to reduce premature operator fatigue. According to some embodiments, damping mounts 38 may be configured to operably couple vehicle cab 12 to vehicle 10 such that vehicle cab 12 is not intended to pivot with respect to vehicle 10.

Pivoting cab mounts 16 and connecting cab mounts 18 may include a lynch pin retainer 52, which includes a plate 54 and a pair of brackets 56 extending from plate 54 (see, e.g., FIG. 3D). Plate 54 may further include an aperture (not shown) configured such that mounting stud 42 of damping mount 38 may extend therethrough and attach damping mount 38 to plate 54. For example, plate 54 may define a relatively planar body having an aperture located in a central region of plate 54. Each of brackets 56 may be provided with an aperture 58 configured to receive lynch pin 32. For example, lynch pin 32 may include threads, and one of apertures 58 may include threads, such that lynch pin 32 may threadedly engage aperture 58 of bracket 56. This may provide for ease of assembly and/or disassembly.

According to some embodiments, pivoting cab mounts 16 and/or connecting cab mounts 18 may be operably coupled to one another independent of vehicle cab 12. For example, one or more of pivoting cab mounts 16 may be connected to a corresponding one of connecting cab mounts 18. For example, as schematically-depicted in FIG. 3B, each of pivoting cab mounts 16 may be connected to one of connecting cab mounts 18 via, for example, one of brackets 56, which extends between pivoting cab mount 16 and connecting cab mount 18.

When assembled, damping mount 38's housing 40 may be received in retainer 50 located along a lower portion of vehicle cab 12, and fasteners 48 may position flange 44 adjacent to retainer 50 by sandwiching flange 44 between fasteners 48 and vehicle cab 12. When vehicle cab 12 is pivoted into an operational position, such that pivoting cab mounts 16 and connecting cab mounts 18 are positioned on frame mounts 20, brackets 56 of lynch pin retainer 52 may extend on either side of frame link 24, such that lynch pin 32 may extend through each aperture 58 of brackets 56 and through aperture 30 of frame link 24. In such an exemplary arrangement, lynch pin retainer 52 may be secured to frame mount 20.

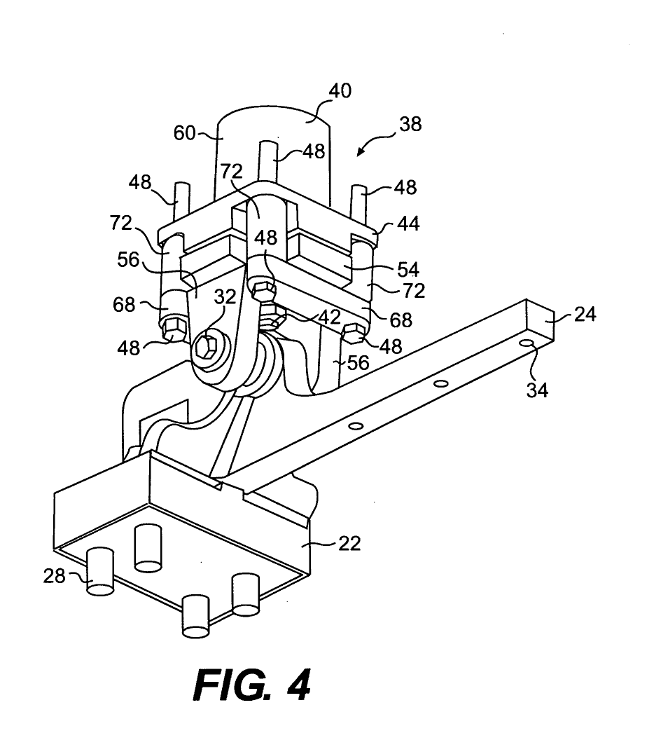

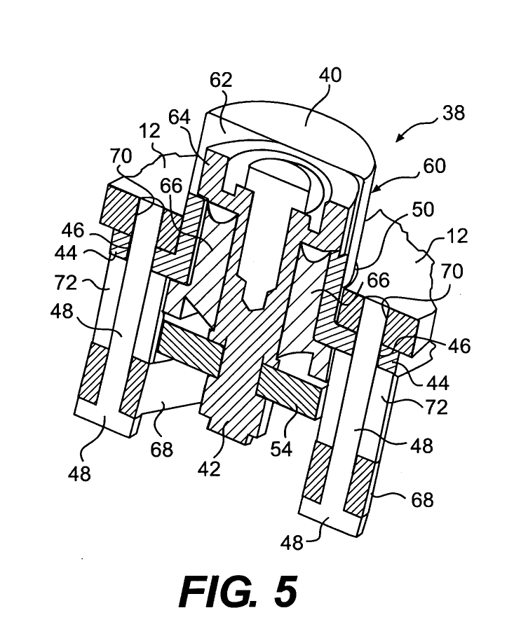

The exemplary embodiment of cab mount schematically-depicted in FIGS. 4 and 5 includes a damping mount 38 having a viscous member 60 for absorbing shocks and vibrations. Viscous member 60 is generally cup-shaped as defined by housing 40 and housing flange 44. Housing 40 defines a fluid/gas-containing chamber 62, which receives a piston 64 configured to reciprocate within chamber 62. Piston 64 is connected to mounting stud 42, which extends through a hole in an elastic member 66. Viscous member 60 is received in retainer 50 located in vehicle cab 12 such that housing 40 is inverted, and mounting stud 42 is affixed to plate 54 such that an elastic member 66 is sandwiched between plate 54 and piston 64 as the damping mount 38 supports the weight of vehicle cab 12 on elastic member 66 (see, e.g., FIG. 5).

Damping mount 38 may further include one or more stop members 68 for reducing load on mounting stud 42 and/or for limiting separation of vehicle cab 12 from vehicle 10 (e.g., preventing vehicle cab 12 from becoming completely separated from vehicle frame 14), for example, when vehicle 10 rolls over onto its side or onto cab 12. Stop members 68 may be relatively bar-shaped and may be connected to vehicle cab 12 via one or more fasteners 48 (e.g., four bolts). For example, fasteners 48 may extend through bar-shaped stop members 68 (see FIG. 4) positioned beneath plate 54 and aperture 46 in flange 44 of damping mount 38's housing 40. Fasteners 48 threadedly engage threaded holes 70 in vehicle cab 12, but fasteners 48 do not threadedly engage damping mount 38. Stop members 68 and the flange 44 of the housing 40 are separated by one or more tubular spacers 72 mounted on fasteners 48, such that stop members 68 are spaced a sufficient distance from the underside of plate 54 to permit the damping mount 38 to absorb shocks and vibrations (i.e., by permitting vehicle cab 12 to move vertically and/or horizontally relative to vehicle 10 as vehicle 10 experiences shocks and vibrations).

Fasteners 48 sandwich flange 44 of the damping mount 38's housing 40 between spacers 72 and vehicle cab 12, but fasteners 48 do not create a physical joint between fasteners 48 and damping mount 38 that transmits force between fasteners 48 and damping mount 38. For example, the threads of fasteners 48 do not threadedly engage flange 44 of damping mount 38 due to apertures 46 in flange 44 having a standard manufacturing clearance with respect to fasteners 48.

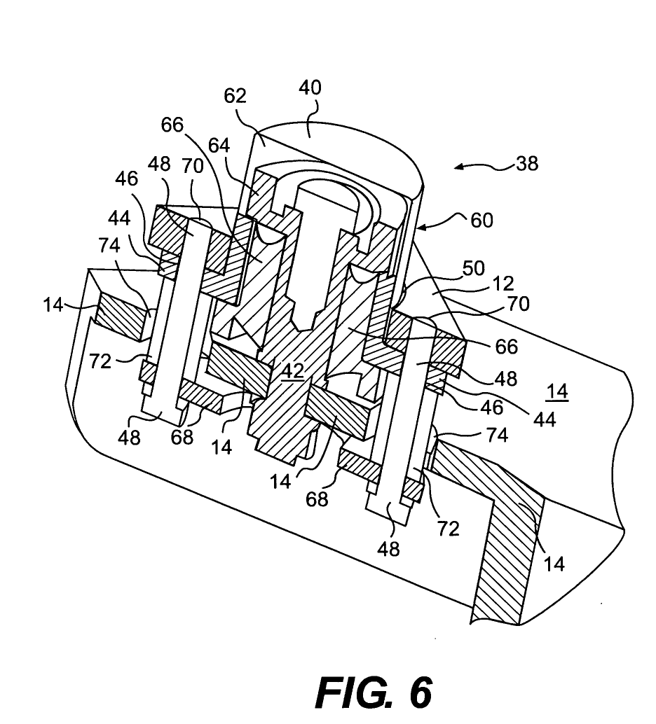

According to the exemplary embodiment schematically-depicted in FIG. 6, mounting stud 42 may be connected directly to vehicle frame 14. For example, mounting stud 42 is affixed to vehicle frame 14, such that elastic member 66 is sandwiched between vehicle frame 14 and piston 64 as damping mount 38 supports the weight of vehicle cab 12 on elastic member 66. Stop member 68 may be connected to vehicle cab 12 via, for example, four fasteners 48. Each of the four fasteners 48 extends from a side of vehicle frame 14 opposite vehicle cab 12 (i.e., the underside of vehicle frame 14) through an aperture 74 in vehicle frame 14 and aperture 46 in the flange 44 of the damping mount 38's housing 40. Each of the four fasteners 48 threadedly engages threaded holes 70 in vehicle cab 12, but the four fasteners 48 do not threadedly engage the damping mount 38. Stop member 68 and flange 44 of housing 40 are separated by spacers 72 mounted on each of the four fasteners 48, such that stop member 70 is spaced a sufficient distance from the underside of the vehicle frame 14 to permit damping mount 38 to absorb shocks and vibrations experienced by the vehicle frame 14. Fasteners 48 sandwich flange 44 of the viscous member's housing 40 between spacers 72 and vehicle cab 12, but fasteners 48 do not create a physical joint between fasteners 48 and the damping mount 38.

Exemplary damping mounts 38 have been described as being mounted in vehicle cab 12, with mounting stud 42 connecting damping mount 38 to vehicle frame 14 and fasteners 48 connecting stop member 68 to vehicle cab 12, sandwiching housing 40's flange 44 between vehicle cab 12 and spacers 72. It is also contemplated that damping mounts 38 may be mounted in vehicle 10 (e.g., in vehicle frame 14), with mounting stud 42 connecting damping mount 38 to vehicle cab 12 and fasteners 48 connecting stop member(s) 68 to vehicle 10, sandwiching housing 40's flange 44 between vehicle frame 14 and spacers 72.

### INDUSTRIAL APPLICABILITY

The exemplary system and method may be applicable to any type of vehicle where increased operator comfort, operator protection, and/or ease of access to other vehicle components, among other things, may be desired. By virtue of providing a vehicle with exemplary system and method, one or more of these desired aspects may be achieved. The operation of exemplary system and method will now be explained.

Exemplary vehicle cab 12 includes a pair of pivoting cab mounts 16 and a pair of connecting cab mounts 18, and frame 14 includes frame mounts 20 and pivoting cab mounts 16, such that vehicle cab 12 is configured to pivot with respect to frame mounts 20 when connecting cab mounts 18 are disconnected from frame mounts 20. By virtue of exemplary vehicle cab 12 being configured to pivot (e.g., as shown in FIGS. 1, 3A, and 3B), inspection and service of components located underneath or in the vicinity of vehicle cab 12 may be rendered more feasible.

For vehicles that may routinely encounter uneven terrain and/or that may be exposed to abrupt shocks, for example, it may be desirable to provide an operator with an environment that is at least partially isolated from such incidents. Exemplary vehicle cab 12 includes damping mounts 38, which may be configured to at least partially inhibit (e.g., reduce and/or dampen) transmission of shocks and vibrations from vehicle frame 14 to vehicle cab 12. For example, as vehicle 10 encounters uneven terrain, which transmits shocks and vibrations to vehicle 10, transmission of such shocks and vibrations may be at least partially inhibited by damping mounts 38. This may serve to reduce the magnitude of shocks and vibrations transmitted to an operator in vehicle cab 12. As a result, damping mounts 38 may provide a more comfortable environment for the operator, which may act to reduce premature operator fatigue.

For example, damping mounts 38 serve to attach vehicle cab 12 to vehicle 10 (e.g., to frame 14) to reduce the transfer of shocks and vibrations from vehicle frame 14 to vehicle cab 12, thereby increasing the comfort of the vehicle operator. The weight of vehicle cab 12 rests on damping mount 38's elastic member 66. As vehicle 10's frame 14 experiences shocks and vibrations, the shocks and vibrations are at least partially absorbed by damping mount 38's elastic member 66 and/or by transfer of fluid between opposite sides of the damping mount 38's piston 64. If, however, vehicle 10 travels across a steep incline and/or rolls over, and the vehicle cab 12 is pulled away from vehicle frame 14 (i.e., via the force of gravity), stop member(s) 68 abut against the underside of the plate 54 (or frame 14 (see, e.g., FIG. 6)) and transmit a force to vehicle cab 12 via fasteners 48, which secure stop member(s) 68 to vehicle cab 12. This may serve to limit the amount of load on mounting stud 42 and/or limit the amount of separation of vehicle cab 12 from vehicle 10 (e.g., thereby preventing vehicle cab 12 from being pulled away from vehicle frame 14).

It will be apparent to those skilled in the art that various modifications and variations can be made to the exemplary embodiments disclosed. Other embodiments will be apparent to those skilled in the art from consideration of the specification and practice of the disclosed embodiments. It is intended that the specification and examples be considered as exemplary only, with a true scope being indicated by the following claims and their equivalents.

What is claimed is:

1. A system for operably coupling a vehicle cab to a vehicle, the system comprising:
a damping mount configured to at least partially inhibit transmission of shocks and vibrations from the vehicle to the vehicle cab;
a mounting stud configured to operably couple the damping mount to one of the vehicle and the vehicle cab;
at least one stop member configured to limit at least one of load on the mounting stud and separation of the vehicle cab from the vehicle; and
at least one fastener configured to operably couple the at least one stop member and the damping mount to the other of the vehicle and the vehicle cab.

2. The system of claim 1, wherein the mounting stud is configured to operably couple the damping mount to the vehicle, and the at least one fastener is configured to operably couple the stop member and the damping mount to the vehicle cab.

3. The system of claim 1, wherein vehicle includes a frame and the mounting stud is configured to operably couple the damping mount to the frame.

4. The system of claim 1, wherein the damping mount includes a viscous member.

5. The system of claim 4, wherein the viscous member includes an elastic member and a piston configured to at least partially absorb shocks and vibrations.

6. The system of claim 1, including a spacer mounted on the at least one fastener such that the at least one fastener sandwiches the damping mount between the spacer and the other of the vehicle and the vehicle cab.

7. The system of claim 1, wherein the vehicle includes a frame, and the system is configured such that upon an amount of separation of the vehicle cab from the vehicle, the at least one stop member abuts the frame and limits at least one of load on the mounting stud and the amount of separation between the vehicle cab and the vehicle.

8. The system of claim 1, wherein the damping mount is configured to be sandwiched between the vehicle cab and the vehicle.

9. The system of claim 1, wherein the at least one fastener includes four fasteners.

10. The system of claim 1, wherein the at least one stop member includes two stop members.

11. The system of claim 1, including a cab mount and a frame mount configured to be coupled to one another such that the vehicle cab and the vehicle are pivotally coupled to one another, wherein one of the cab mount and the frame mount includes the damping mount.

12. A system for operably coupling a vehicle cab to a vehicle, the system comprising:
a cab mount configured to be operably coupled to the vehicle cab; and
a frame mount configured to be operably coupled to the vehicle and to the cab mount,
wherein the cab mount and the frame mount are configured to be coupled to one another such that the vehicle cab and the vehicle are pivotally coupled to one another, and
wherein one of the cab mount and the frame mount includes a damping mount configured to provide damping between the vehicle cab and the vehicle.

13. The system of claim 12, wherein the damping mount includes a piston and a housing, wherein the piston and the housing are configured such that the piston reciprocates within the housing to provide damping between the vehicle cab and the vehicle.

14. The system of claim 13, wherein the damping mount is configured to be received within a receptacle in the vehicle cab.

15. The system of claim 12, wherein the cab mount further includes a lynch pin retainer configured to receive a lynch pin.

16. The system of claim 15, including a lynch pin, wherein the lynch pin includes threads configured to engage the lynch pin retainer.

17. The system of claim 15, wherein the frame mount includes a link configured to receive a lynch pin, wherein the cab mount and the vehicle mount are configured to be connected to one another via a lynch pin.

18. The system of claim 12, including two cab mounts, wherein the two cab mounts are operably coupled to one another independent of the vehicle cab.

19. A vehicle comprising:
a cab from which to operate the vehicle;
a vehicle frame; and
a system for operably coupling the cab to the vehicle frame, the system including
at least one cab mount operably coupled to the cab, and
at least one frame mount operably coupled to the vehicle frame,
wherein the cab mount and the frame mount are configured to be operably coupled to one another such that the cab and the vehicle are pivotally coupled to one another, and
wherein one of the cab mount and the frame mount includes a damping mount configured to provide damping between the cab and the vehicle.

20. The vehicle of claim 19, wherein the at least one cab mount includes two cab mounts, and the at least one frame mount includes two frame mounts.

21. The vehicle of claim 20, wherein one of the two cab mounts and one of the two frame mounts are pivotally coupled to one another.

22. The vehicle of claim 21, wherein another of the two cab mounts and another of the two frame mounts are removably coupled to one another such that when uncoupled, the one cab mount and the one frame mount are configured pivot with respect to one another, thereby allowing the cab to pivot with respect to the vehicle.

23. A method for providing comfort to a vehicle operator and access to vehicle components, the method comprising:
mounting a cab to a vehicle such that the cab is supported by at least one mount configured to
provide damping support between the cab and the vehicle,
limit separation of the cab from the vehicle, and
operably couple the cab to the vehicle such that the cab may be pivoted with respect to the vehicle.
